(19) United States
(12) Patent Application Publication
(10) Pub. No.: US 2009/0301595 A1
(43) Pub. Date: Dec. 10, 2009

(54) MULTI-LAYER STRUCTURE BASED ON FLUORIDE POLYMER FUNCTIONALISED BY IRRADIATION AND PVC

(75) Inventors: Anthony Bonnet, Beaumont Le Roger (FR); Francois Beaume, Bemay (FR); Aude Lapprand, Bernay (FR); Frank Vandekerckhove, Meulebeke (BE)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/297,402

(22) PCT Filed: Mar. 20, 2007
(86) PCT No.: PCT/FR2007/050964

§ 371 Date: Mar. 6, 2009

(30) Foreign Application Priority Data
Apr. 19, 2006 (FR) 0603436

(51) Int. Cl. F16L 9/14; B32B 27/30; B32B 1/08; B32B 1/02

(52) U.S. Cl. 138/137; 428/421; 428/35.7; 138/141

(57) ABSTRACT

The invention relates to a multi-layer structure including placed one against the other, at least one layer of fluoride polymer onto which at least one unsaturated monomer has been grafted by irradiation, and at least one layer of PVC. According to a 1^{st} form, the multi-layer structure may include in order placed against one another: possibly a layer of fluoride polymer; a layer of fluoride polymer grafted by irradiation; and layer of PVC. According to a 2^{nd} form, the multi-layer structure includes in order placed against one another: possibly, a layer of fluoride polymer; a layer of fluoride polymer grafted by irradiation; a layer of PVC; a layer of fluoride polymer grafted by irradiation; and possibly a layer of a fluoride polymer. According to a 3^{rd} form, the multi-layer structure includes in order placed against one another: a layer of PVC; a layer of fluoride polymer grafted by irradiation; a layer of PVC. Said structure may be shaped into films, bottles, tanks, containers, pipes and containers of all kinds.

### FIELD OF THE INVENTION

The present invention relates to a multilayer structure comprising at least one layer based on a fluoropolymer modified by radiation grafting and at least one layer based on a PVC. This structure may be in the form of films, bottles, tanks, containers, pipes, hoses and receptacles of any kind. The invention also relates to the uses of these structures.

### TECHNICAL PROBLEM

Fluoropolymers, for example those based on vinylidene fluoride (VDF of formula CF₂═CH₂) such as PVDF (polyvinylidene fluoride) are known to provide excellent mechanical stability properties, and good ageing resistance. These properties are exploited in varied fields of application. Mention may for example be made of the manufacture of extruded or injection-moulded parts for the chemical engineering industry or for microelectronics, use in the form of sealing sleeves for the transportation of gases or hydrocarbons, production of films or coatings providing protection in the architectural field, and production of protective components for electrical engineering uses. They are especially know and appreciated for their remarkable chemical resistance due to the stability of the C—F bond as well as their barrier properties (for example against fuels).

The chlorinated polymers such as PVC or chlorinated PVC are two polymers commonly used, less expensive then fluoropolymers, which are frequently employed in the fabrication of hoses or tubes, fittings and joints. The chlorinated polymers offer an excellent mechanical rigidity, an excellent abrasion resistance as well as a good fire resistance. However, they have a chemical resistance (especially in the presence of aggressive chemical products) and an ageing resistance, which are less important then the fluoropolymers.

A multilayer structure that associates a fluoropolymer and a chlorinated polymer allows improving the chemical resistance and the ageing resistance of the chlorinated polymer (by the fluoropolymer) while guarding the good mechanical properties of the chlorinated polymer. This permits also to reduce the cost of a structure containing only a fluoropolymer and for certain applications to reduce the barrier properties of the structure as well.

However, due to their chemical natures, the fluoropolymers are bonded with difficulties to other polymers. A problem intended to be solved by the invention is to propose a associated multilayer structure (one against the other) of a layer of a chlorinated polymer and a fluoropolymer, that presents no delamination between these two layers.

### PRIOR ART

Application EP 1484346 published on 8 Dec. 2004 describes multilayer structures comprising a radiation-grafted fluoropolymer. The structures may be in the form of bottles, tanks, containers, pipes or hoses.

Application EP 1541343 published on 8 Jun. 2005 describes a multilayer structure based on a fluoropolymer modified by radiation grafting, for storing or transporting chemicals.

In that application, “chemicals” is understood to mean products that are corrosive or dangerous, or else products whose purity it is desired to maintain. Application EP 1101994 published on 23 May 2001 describes a petrol pipe based on a fluoropolymer and on a thermoplastic resin, which may be a polyamide or a polyolefin.

The fluoropolymer is preferably an ethylene/TFE copolymer or a TFE/HFP/VDF terpolymer, optionally modified by grafting.

None of these applications refers to a multilayer structure comprising a layer of fluoropolymer modified by radiation grafting and a PVC layer.

Application EP 1329309 published on 23 Jul. 2003 describes a multilayer structure comprising a layer of a fluoropolymer and a layer of chlorinated PVC. This application does not describe a fluoropolymer modified by radiation grafting. Additionally, the adhesion between the two layers is obtained by an intermediate layer of polyamide.

The application EP 1338612 published 27 august 2003 describes a multilayer structure comprising a layer of a functionalized fluoropolymer and a layer of another polymer hat can be for ex maple a polyvinylidene chloride. This application does not describe PVC. The functionalized fluoropolymer is obtained directly by copolymerization in presence of a functional monomer or by grafting this monomer in the molten state in presence of a radical initiator. The functionalized fluoropolymer is not a fluoropolymer modified by radiation grafting.

### FIGURES

FIG. 1a describes a multilayer structure 1 according to the invention, comprising a PVC layer 3 and a radiation-modified fluoropolymer layer 2.

FIG. 1b describes a multilayer structure 4 according to the invention, comprising a PVC layer 3, a radiation-modified fluoropolymer layer 2 and an additional fluoropolymer layer 5.

FIG. 1c describes a tube 6 according to the invention, comprising a PVC inner layer 8 and a radiation-modified fluoropolymer outer layer 7.

FIG. 1d describes a tube 9 according to the invention, comprising a radiation-modified fluoropolymer inner layer 8 and a PVC outer layer 7.

FIG. 2a describes a multilayer structure 10 according to the invention, comprising a PVC layer 3 placed between two radiation-modified fluoropolymer layers 2 and 2′.

FIG. 2b describes a tube 11 according to the invention, comprising a PVC intermediate layer 8 placed between two radiation-modified fluoropolymer layers 7 and 7′. The layer 7 is the outer layer and the layer 7′ is the inner layer.

FIG. 3a describes a multilayer structure 12 according to the invention, comprising a radiation-modified fluoropolymer layer 2 placed between two PVC layers 3 and 3′.

FIG. 3b describes a tube 13 according to the invention, comprising a radiation-modified fluoropolymer intermediate layer 7 placed between two PVC layers 8 and 8′. The layer 8 is the outer layer and the layer 8′ is the inner layer.

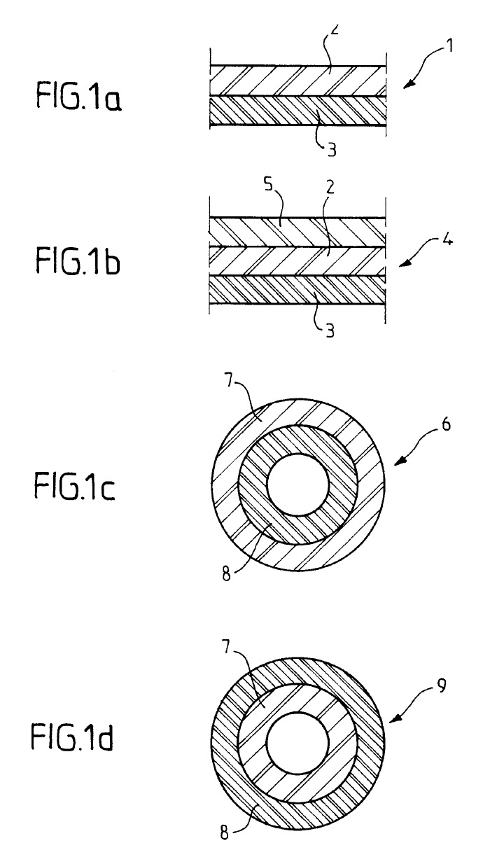

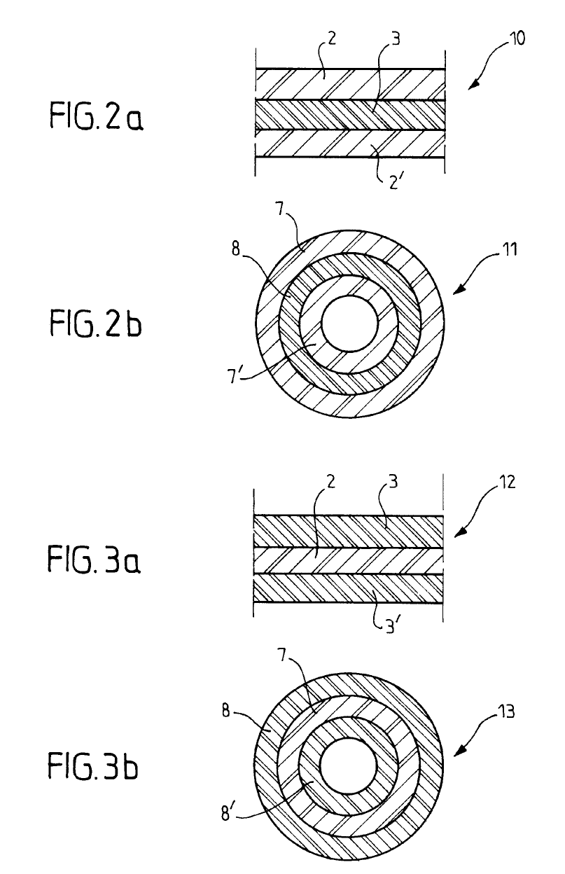

### BRIEF DESCRIPTION OF THE INVENTION

The invention relates to a multilayer structure comprising, placed against one another, at least one fluoropolymer layer onto which at least one unsaturated monomer has been radiation-grafted, and at least one PVC layer.

According to a first embodiment, the multilayer structure may comprise in the following order placed against one another:
optionally, a fluoropolymer layer;
a radiation-grafted fluoropolymer layer; and
a PVC layer.

According to a second embodiment, the multilayer structure comprises in the following order placed against one another:
optionally, a fluoropolymer layer;
a radiation-grafted fluoropolymer layer;
a PVC layer;
a radiation-grafted fluoropolymer layer; and
optionally, a fluoropolymer layer.

According to a third embodiment, the multilayer structure comprises in the following order placed against one another:
a PVC layer;
a radiation-grafted fluoropolymer layer; and
a PVC layer.

In these structures, according to one variant, the radiation-grafted fluoropolymer layer is replaced with a layer of a fluoropolymer/radiation-grafted fluoropolymer blend.

Preferably, to improve the adhesion between the PVC layer and the radiation-grafted fluoropolymer layer, the PVC is blended with at least one component capable of reacting with the grafted unsaturated polar monomer.

This structure may be in the form of films, bottles, tanks, containers, pipes or hoses and receptacles of any kind.

### DETAILED DESCRIPTION OF THE INVENTION

As regards the fluorinated polymer, this denotes any polymer having in its chain at least one monomer chosen from compounds that contain a vinyl group capable of opening in order to be polymerized and that contains, directly attached to this vinyl group, at least one fluorine atom, a fluoroalkyl group or a fluoroalkoxy group.

As examples of monomers, mention may be made of vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD); the product of formula CF₂═CFOCF₂CF(CF₃)OCF₂CF₂X in which X is SO₂F, CO₂H, CH₂OH, CH₂OCN or CH₂OPO₃H; the product of formula CF₂═CFOCF₂CF₂SO₂F; the product of formula F(CF₂)ₙCH₂OCF═CF₂ in which n is 1, 2, 3, 4 or 5; the product of formula R₁CH₂OCF═CF₂ in which R₁ is hydrogen or F(CF₂)_{z} and z is 1, 2, 3 or 4; the product of formula R₃OCF═CH₂ in which R₃ is F(CF₂)_{z}— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer; it may also include non-fluorinated monomers such as ethylene or propylene.

As an example, the fluoropolymer is chosen from:
homopolymers and copolymers of vinylidene fluoride (VDF) preferably containing at least 50% VDF by weight, more preferably at least 75% VDF by weight. The copolymer is preferably chosen from chlorotrifluoroethylene (CTFE), hexafluoropropylene (HFP), trifluoroethylene (VF3) and tetrafluoroethylene (TFE);
homopolymers and copolymers of trifluoroethylene (VF3); and
copolymers, and especially terpolymers, combining the residues of chlorotrifluoroethylene (CTFE), tetrafluoroethylene (TFE), hexafluoropropylene (HFP) and/or ethylene units and optionally VDF and/or VF3 units;
mention may also be made of ethylene/tetrafluoroethylene (ETFE) copolymers.

Advantageously, the fluoropolymer is a poly(vinylidene fluoride) (PVDF) homopolymer or copolymer. Preferably, the PVDF contains, by weight, at least 50%, more preferably at least 75% and better still at least 85% VDF. The comonomer is advantageously HFP.

Advantageously, the PVDF has a viscosity ranging from 100 Pa·s to 3000 Pa·s, the viscosity being measured at 230° C. with a shear rate of 100 s⁻¹ using a capillary rheometer. This is because these PVDFs are well suited to extrusion and to injection moulding. Preferably, the PVDF has a viscosity ranging from 300 Pa·s to 1200 Pa·s, the viscosity being measured at 230° C. with a shear rate of 100 s⁻¹ using a capillary rheometer.

The, PVDFs sold under the brand name KYNAR® 710 or 720 are perfectly suitable for this formulation.

As regards the radiation-grafted fluoropolymer, this is obtained by the following process:

In a first step, the fluoropolymer is blended beforehand with the unsaturated polar monomer by any melt-blending technique known in the prior art. The blending step is carried out in any blending device, such as extruders or mixers used in the thermoplastics industry. Preferably, an extruder will be used to make the blended compound in the form of granules. The grafting takes place on a compound (throughout the mass) and not on the surface of a powder, as described for example in document U.S. Pat. No. 5,576,106.

In the compound that has to be irradiated, the proportion of fluoropolymer is, by weight, between 80 and 99.9% per 0.1 to 20% of unsaturated monomer, respectively. Preferably, the proportion of fluoropolymer is from 90 to 99% per 1 to 10% of unsaturated monomer, respectively.

In a second step, the compound of the first step is irradiated (beta (β) or gamma (γ) irradiation) in the solid state using an electron or photon source with an irradiation dose of between 10 and 200 kGray, preferably between 10 and 150 kGray. The compound may for example be placed in polyethylene bags, which are then sealed after the air has been expelled. Advantageously, the dose is between 2 and 6 Mrad and preferably between 3 and 5 Mrad. It is particularly preferred to carry out the irradiation with a cobalt 60 bomb.

The grafted unsaturated monomer content is, by weight, between 0.1 and 5% (that is to say the grafted unsaturated monomer corresponds to 0.1 to 5 parts per 99.9 to 95 parts of fluoropolymer), advantageously from 0.5 to 5% and preferably from 0.9 to 5%. The grafted unsaturated monomer content depends on the initial content of the unsaturated monomer in the fluoropolymer/unsaturated monomer compound to be irradiated. It also depends on the efficiency of the grafting, and therefore on the duration and the energy of the irradiation.

In a third step any unsaturated monomer that has not been grafted and the residues released by the grafting, especially HF, can then be removed. This last step may be necessary if non-grafted unsaturated monomer is liable to impair adhesion or cause toxicological problems. This operation may be carried out using techniques known to those skilled in the art. A vacuum degassing operation may be applied, optionally applying heating at the same time. It is also possible to dissolve the modified fluoropolymer in a suitable solvent, such as for example N-methylpyrrolidone, and then to precipitate the polymer in a non-solvent, for example in water or in an alcohol. Or else to wash the modified fluoropolymer using a solvent that is inert with respect to the fluoropolymer and to the grafted functional groups. For example, when maleic anhydride is grafted, it is possible to wash with chlorobenzene.

One of the advantages of this radiation grafting process is that it is possible to obtain higher grafted unsaturated monomer contents than with the conventional grafting processes using a radical initiator. Thus, with the radiation grafting process, it is typically possible to obtain contents of greater than 1% (one part of unsaturated monomer per 99 parts of fluoropolymer), or even greater than 1.5%, something that is not possible with a conventional grafting process carried out in an extruder.

The process is as well easier to apply as a grafting process in an extruder because the latter requires the adaptation of the radical initiator to the fluoropolymer. Certain fluoropolymers possess elevated melting temperatures superior to 200° C., and its sometimes not possible to find a radical initiator having an appropriated decomposition speed (meaning that has an appropriated decomposition temperature).

Moreover, the radiation grafting takes place “cold” typically at temperatures below 100° C., or even below 50° C., so that the fluoropolymer/unsaturated polar monomer compound is not in the melt state, as in the case of a conventional grafting process carried out in an extruder. One essential difference is therefore that, in the case of a semicrystalline fluoropolymer (as is the case with PVDF for example), the grafting takes place in the amorphous phase and not in the crystalline phase, whereas homogeneous grafting takes place in the case of melt-grafting in an extruder. The unsaturated polar monomer is therefore not distributed along the fluoropolymer chains in the same way in the case of radiation grafting and in the case of grafting carried out in an extruder. The modified fluorinated product therefore has a different distribution of unsaturated polar monomer among the fluoropolymer chains compared with a product obtained by grafting carried out in an extruder.

During this grafting step, it is preferable to prevent oxygen from being present. It is therefore possible to remove the oxygen by flushing the fluoropolymer/unsaturated polar monomer compound with nitrogen or argon.

With regard to the unsaturated polar monomer, this possesses a C═C double bond, and at least one polar functional group that may be one of the following functional groups:
a carboxylic acid;
a carboxylic acid salt;
a carboxylic acid anhydride;
an epoxide;
a carboxylic acid ester;
a silyl;
an alkoxysilane;
a carboxylic acid amide;
a hydroxyl;
an isocyanate.

It is also possible to envisage using mixtures of several unsaturated monomers.

Unsaturated carboxylic acids having 4 to 10 carbon atoms and their functional derivatives, particularly their anhydrides, are particularly preferred unsaturated monomers. Mention may be made by way of examples of unsaturated monomers of methacrylic acid, acrylic acid, maleic acid, fumaric acid, itaconic acid, citraconic acid, undecylenic acid, allylsuccinic acid, cyclohex-4-ene-1,2-dicarboxylic acid, 4-methylcyclohex-4-ene-1,2-dicarboxylic acid, bicyclo[2.2.1]hept-5-ene-2,3-dicarboxylic acid, x-methylbicyclo-[2.2.1]hept-5-ene-2,3-dicarboxylic acid, zinc, calcium or sodium undecylenate, maleic anhydride, itaconic anhydride, citraconic anhydride, dichloromaleic anhydride, difluoromaleic anhydride, crotonic anhydride, glycidyl acrylate, glycidyl methacrylate, allyl glycidyl ether and vinylsilanes, such as vinyltrimethoxysilane, vinyltriethoxysilane, vinyltriacetoxysilane and γ-methacryloxypropyltrimethoxysilane. Other examples of unsaturated monomers comprise C₁-C₈ alkyl esters or glycidyl ester derivatives of unsaturated carboxylic acids, such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate and diethyl itaconate; amide derivatives of unsaturated carboxylic acids, such as acrylamide, methacrylamide, the monoamide of maleic acid, the diamide of maleic acid, the N-monoethylamide of maleic acid, the N,N-diethylamide of maleic acid, the N-monobutylamide of maleic acid, the N,N-dibutylamide of maleic acid, the monoamide of fumaric acid, the diamide of fumaric acid, the N-monoethylamide of fumaric acid, the N,N-diethylamide of fumaric acid, the N-monobutylamide of fumaric acid and the N,N-dibutylamide of fumaric acid; imide derivatives of unsaturated carboxylic acids, such as maleimide, N-butylmaleimide and N-phenylmaleimide; and metal salts of unsaturated carboxylic acids, such as sodium acrylate, sodium methacrylate, potassium acrylate, potassium methacrylate and zinc, calcium or sodium undecylenate.

Excluded from unsaturated monomers are those that have two double bonds C═C, which could result in crosslinking of the PVDF, such as for example diacrylates or triacrylates. From this point of view, maleic anhydride, just like zinc, calcium and sodium undecylenates constitute good graftable compounds as they have little tendency to homopolymerize or even to cause crosslinking.

Advantageously maleic anhydride is used as this monomer has the following advantages:
it is solid and can be easily introduced with the fluoropolymer granules before melt blending;
it allows good adhesion properties to be obtained;
it is particularly reactive with respect to functional groups of a functionalized polyolefin, especially when they are epoxide functional groups; and
unlike other unsaturated monomers, such as (meth)acrylic acid or acrylic esters, it does not homopolymerize and does not have to be stabilized.

With regard to the PVC, this may be a polymer comprising at least 50% vinyl chloride (VCM of formula CH₂═CHCl) by weight. It may be a VCM homopolymer or a copolymer of VCM and at least one comonomer copolymerizable with VCM. The comonomer may for example be an olefin, such as ethylene or propylene, a vinyl ester, such as for example vinyl acetate, vinyl propionate or vinyl stearate, esters of (meth)acrylic acids, such as methyl acrylate or ethyl acrylate, or fumaric, maleic and/or itaconic acids, and also acrylonitrile, styrene or trifluorochloroethylene. The comonomer can be as well vinylidene chloride, but in that case, in order to maintain a good thermal resistance, the ratio by weight of VCM has to be superior to 70%.

The PVC may be prepared by bulk, suspension, emulsion, microsuspension or suspended emulsion polymerization. The difference between the products lies essentially in the particle size of the polymer particles obtained.

The PVC may include up to 20% by weight of various additives, such as pigments or fillers, plasticizers, lubricants, UV stabilizers, heat stabilizers, processing aids, antioxidants, etc. The additive may also be a polymer or copolymer whose function is to provide flexibility or to improve impact strength. For example, it may be polyvinyl acetate, polyvinyl butyral or polyvinyl alcohol. It may be one of the family of phthalate plasticizers, more particularly branched or unbranched alkyl phthalates, such as diethylhexyl phthalate (DEHP), diisononyl phthalate, phthalates of C₇-C₁₁ linear alcohols or mixtures thereof, and diisodecyl phthalate. It may be in the family of heat stabilizers consisting of barium, zinc, tin, calcium or zinc organometallic soaps optionally combined with costabilizers, such as epoxided soybean oil. One particularly preferred heat stabilizer is an octyltin thioglycolate/dioctyltin thioglycolate mixture.

The term PVC also encompasses within the meaning of the present invention expanded (or foamed) PVC and chlorinated PVC (CPVC). CPVC is a PVC that has undergone chlorination in the presence of chlorine and a source of free radicals (irradiation or UV). For further details about CPVC, the reader may refer to Ullmann's Encyclopaedia of Industrial Chemistry, Vol. A21, Fifth edition, page 737. The PVDC presents more poorly mechanical properties as the PVC or the CPVC (see table I afterwards):

TABLE I

| | Fracture | Flexural | Tensile |
|---|---|---|---|
| | stress | strength | strength |
| | [MPa] | [MPa] | [MPa] |
| rigid PVC | 50 | 70-80 | 2400 |
| CPVC | 60 | 2800 | 2800 |
| PVDC | 21-35 | 15-20 | 350-260 |

Values from <<Précis de matières plastiques>>, Nathan, 4ème édition, p. 49, ISBN: 2-12-355352-2

Additionally it possesses a low temperature resistance and decomposes above 125° C. (see Encyclopaedia of Chemical Technology, Vol. 23, 3^{rd} edition, Wiley&Son, p. 780, ISBN: 0-471-02076-1).

Preferably, to improve the adhesion between the PVC layer and the radiation-grafted fluoropolymer layer, the PVC may also include at least one component capable of reacting with the grafted unsaturated polar monomer. The component may be a molecule or a polymer or else an oligomer. Thus, for example, if an unsaturated carboxylic acid (e.g. undecylenic acid) or an unsaturated carboxylic acid anhydride (e.g. maleic anhydride) has been grafted onto the fluoropolymer, the component will carry one or more amine, hydroxy, isocyanate or epoxide functional groups. Thus, for example, if an unsaturated epoxide (e.g. glycidyl methacrylate), has been grafted onto the fluoropolymer, the component will carry one or more acid or acid anhydride functional groups.

The component may for example be an alkyl isocyanate R—NCO or an alcohol R—OH, R denoting an alkyl or aryl group. The component may be monofunctional (a single functional group per molecule) or polyfunctional (more than one same functional group per molecule).

The compound comprises, by weight, 70 to 99.9 parts, advantageously 80 to 99 parts and preferably 90 to 99 parts of a PVC per 0.1 to 30 parts, advantageously 1 to 20 parts and preferably 1 to 10 parts of the component capable of reacting with the unsaturated polar monomer that is grafted, respectively.

The compound is for example produced by melt blending, using an extruder or any other tool suitable for thermoplastics. Preferably, the component has a molar mass of greater than 70 g/mol and preferably greater than 100 g/mol and even more preferably greater than 200 g/mol. This makes it possible to prevent it from volatilizing during preparation of the compound or from exsuding from the PVC.

With regard to the multilayer structure according to the invention, this comprises, placed against one another, at least one radiation-grafted fluoropolymer layer and at least one PVC layer. This structure may be in the form of films, bottles, tanks, containers, pipes or hoses and receptacles of any kind.

According to a variant, the radiation-grafted fluoropolymer layer is replaced with a layer of a fluoropolymer/radiation-grafted fluoropolymer blend. Preferably, the grafted fluoropolymer is obtained from a PVDF. Preferably, the fluoropolymer is a PVDF. The blend comprises, by weight, 1 to 99 parts, advantageously 10 to 90 parts, preferably 10 to 75 parts and even more preferably 10 to 50 parts of a radiation-grafted fluoropolymer per 99 parts to 1 part, advantageously 90 to 10 parts, preferably 90 to 25 parts and even more preferably 90 to 50 parts of a fluoropolymer, respectively.

One example of a structure comprises, in the following order, placed against one another:
a radiation-grafted fluoropolymer layer;
a PVC layer.

According to a variant, the layer of radiation-grafted fluoropolymer (optionally as a blend with a fluoropolymer) is covered with a fluoropolymer layer, preferably a PVDF layer. The radiation-grafted fluoropolymer layer is a tie layer between the PVDF layer and the PVC layer.

This structure applies for example in the case in which the PVC is a flexible PVC, used for coating a textile backing. The intended textile backing may vary in nature: woven or nonwoven, of natural or synthetic origin, that is to say comprising natural, synthetic or semi-synthetic fibres, optionally blended. In general, the flexible PVC is coated (for example using a knife coating technique) on at least one of the faces of a structural backing, which may be a textile cloth or nonwoven fabric. The structural backing may be made of a plastic, such as polyester, nylon, aramid, etc., or made of a natural material such as viscose, cotton, etc., or glass fibres, etc. It may also be a high-tenacity polyester cloth. Application FR 2305 301 describes a material consisting of a polyester (BIDIM) nonwoven coated with PVC on one side using a transfer process. The nonwoven may optionally be reinforced with a polyester mesh.

The structure therefore comprises a textile backing coated on at least one of its sides with a flexible PVC and placed on at least one of the flexible PVC layers is a radiation-grafted fluoropolymer layer. This structure may serve as a protective tarpaulin, for example in the building industry, or road and rail transport, and for textile architecture (various shelters and industrial premises, such as covered markets, conservatories, camp sites, etc.). It may also be used as fabric for tents, sports mats, container covers, etc.

The flexible PVC may be applied in “wet” paste form, without it being necessary to make it penetrate. The techniques of knife coating, direct coating, transfer coating and calendering may be used.

This structure applies also to the case of a tube or a receptacle comprising, in the following order, from the inside outwards, placed against one another, a PVC layer (inner layer), a radiation-grafted fluoropolymer layer and, optionally, a fluoropolymer layer. The outermost layer (that is say either the radiation-grafted fluoropolymer layer or the fluoropolymer layer) allows the PVC to be protected.

It also applies to the case of a tube or a receptacle comprising, in the following order from the inside outwards, placed against one another, optionally a fluoropolymer layer, a radiation-grafted fluoropolymer layer (interlayer) and a PVC layer (outer layer). The inner layer (i.e. either the radiation-grafted fluoropolymer layer or the fluoropolymer layer) makes it possible to protect the PVC, for example when the fluid in contact with the tube or the receptacle is a corrosive liquid liable to degrade the PVC.

Another example of a structure comprises, in the following order, placed against one another:
a radiation-grafted fluoropolymer layer;
a PVC layer;
a radiation-grafted fluoropolymer layer.

As a variant, at least one of the layers of radiation-grafted fluoropolymer (optionally blended with a fluoropolymer) is covered with a fluoropolymer layer, preferably PVDF. The radiation-grafted fluoropolymer layer is a tie layer between the PVDF layer and the PVC layer.

This structure also applies to the case of a tube or receptacle comprising, in the following order from the inside outwards, placed against one another, optionally a fluoropolymer layer, a radiation-grafted fluoropolymer layer, a PVC layer, a radiation-grafted fluoropolymer layer and, optionally, a fluoropolymer layer. The PVC layer is protected by the two radiation-grafted fluoropolymer layers.

Another example of a structure comprises, in the following order placed against one another:
a PVC layer;
a radiation-grafted fluoropolymer layer;
a PVC layer.

This structure also applies to the case of a tube or receptacle comprising, in the following order from the inside outwards, placed against one another, a PVC layer, a radiation-grafted fluoropolymer layer and a PVC layer.

In the case of these structures in form of a tube, if it is a rigid tube (for example a tube used for transferring fluids or gas), one utilizes an rigid PVC (tensile strength >1000 MPa based on the norm ISO R 527 at 23° C.).

The structure according to the invention may be obtained using conventional thermoplastic conversion techniques. For example the technique of coextrusion may be used for producing tubes or receptacles described above.

With regard to the multilayer structure in form of a tube or receptacle, which can be used for transferring or stocking a fluid or a gas. The fluid or the gas can for example be a fluid or gas corrosive for the PVC; in that case, the layer into contact with the fluid or the gas is a fluoropolymer layer or a layer of fluoropolymer grafted by radiation.

With regard to the fluoropolymer/radiation-grafted fluoropolymer blend, the Applicant has found that good adhesion is obtained when the fluoropolymer is a flexible fluoropolymer, that is to say one having a tensile modulus of between 50 and 1000 MPa (measured according to the ISO R 527 standard at 23° C.), advantageously between 100 and 750 MPa and preferably between 200 and 600 MPa.

Preferably, the viscosity of the flexible fluoropolymer (measured by capillary rheometer at 230° C./100 s⁻¹) is between 100 and 1500 Pa·s, advantageously between 200 and 1000 Pa·s, and preferably between 500 and 1000 Pa·s.

Preferably, the crystallization temperature of the flexible fluoropolymer (measured by DSC according to the ISO 11357-3 standard) is between 50 and 120° C., preferably between 85 and 110° C. Preferably, the flexible fluoropolymer is a PVDF copolymer, more particularly a VDF/HFP copolymer.

Preferably, the viscosity of the radiation-grafted fluoropolymer (measured with a capillary rheometer at 230° C./100 s⁻¹) is between 100 and 1500 Pa·s, advantageously between 200 and 1000 Pa·s and preferably between 500 and 1000 Pa·s.

Preferably, this is a radiation-grafted PVDF. Advantageously, the radiation-grafted PVDF is obtained from a PVDF comprising, by weight, at least 80%, advantageously at least 90%, preferably at least 95% and even more preferably at least 98% VDF. Preferably, this is a PVDF homopolymer (i.e. with 100% VDF).

An example of a compound consists, by weight, of 50% KYNAR 720 onto which maleic anhydride has been grafted (PVDF homopolymer from ARKEMA, with a melt flow index of 20 g/10 min (230° C./5 kg and a melting point of around 170° C.) and 50% of a VDF/HFP copolymer containing 16% HFP and having a viscosity at 230° C. of 900 Pa·s at 100 s⁻¹. The grafting was carried out by blending 2% by weight of maleic anhydride with KYNAR® 720 in a twin-screw extruder. The compound was granulated and then bagged in aluminium-lined bags, and then the bags with their compound were irradiated at 3 Mrad using a cobalt 60 bomb for 17 hours. The product was recovered and vacuum-degassed in order to remove the ungrafted residual maleic anhydride. The weight content of grafted maleic anhydride was 1% (determined by infrared spectroscopy).

1. Multilayer structure comprising, at least one layer comprising a fluoropolymer onto which at least one unsaturated monomer has been radiation-grafted, in direct contact with at least one polyvinyl chloride (PVC) layer.

2. Multilayer structure according to claim 1, comprising, in the following order placed against one another:
optionally, a fluoropolymer layer;
a radiation-grafted fluoropolymer layer; and
a PVC layer.

3. Multilayer structure according to claim 1, comprising, in the following order placed against one another:
optionally, a fluoropolymer layer;
a radiation-grafted fluoropolymer layer;
a PVC layer;
a radiation-grafted fluoropolymer layer; and
optionally, a fluoropolymer layer.

4. Multilayer structure according to claim 1, comprising, in the following order placed against one another:
a PVC layer;
a radiation-grafted fluoropolymer layer; and
a PVC layer.

5. Multilayer structure according to claim 1, wherein the radiation-grafted fluoropolymer layer with consists of a layer of a fluoropolymer/radiation-grafted fluoropolymer blend.

6. Multilayer structure according to claim 5, wherein the blend comprises, by weight, 10 to 90 parts, of a radiation-grafted fluoropolymer per 90 to 10 parts of a fluoropolymer, respectively.

7. Multilayer structure according to claim 5, wherein the fluoropolymer has a tensile modulus of between 50 and 1000 MPa (measured according to the ISO R 527 standard at 23° C.).

8. Multilayer structure according to claim 5, wherein the viscosity of the fluoropolymer (measured by capillary rheometer at 230° C./100 s⁻¹) is between 100 and 1500 Pa·s.

9. Multilayer structure according to claim 5, wherein the crystallization temperature of the fluoropolymer (measured by DSC according to the ISO 11357-3 standard) is between 50 and 120° C.

10. Multilayer structure according to claim 5, wherein the viscosity of the radiation-grafted fluoropolymer (measured with a capillary rheometer at 230° C./100 s⁻¹) is between 100 and 1500 Pa·s.

11. Multilayer structure according to claim 5, wherein the fluoropolymer is a polyvinylidene fluororide (PVDF) copolymer.

12. Multilayer structure according to claim 5, wherein the radiation-grafted PVDF is obtained from a PVDF comprising, by weight, at least 80% VDF.

13. Multilayer structure according to claim 5, wherein the PVC comprises at least one component capable of reacting with the unsaturated polar monomer that is grafted onto the fluoropolymer.

14. Multilayer structure according to claim 13, wherein the PVC comprises, by weight, 70 to 99.9 parts of a PVC per 0.1 to 30 parts of the component capable of reacting with the unsaturated polar monomer that is grafted, respectively.

15. Multilayer structure according to claim 13, wherein the component has a molar mass of greater than 70 g/mol.

16. Multilayer structure according to claim 1, wherein said multilayer structure is selected from the group consisting of films, bottles, tanks, containers, pipes, hoses, tubes and receptacles of any kind.

17. The multilayer structure according to claim 16 wherein said tube comprises, in the following order from the inside to the outside, placed against one another, a PVC layer, a radiation-grafted fluoropolymer layer and, optionally, a fluoropolymer layer.

18. The multilayer structure according to claim 16 wherein said tube comprises, in the following order from the inside outwards, placed against one another, optionally a fluoropolymer layer, a radiation-grafted fluoropolymer layer and a PVC layer.

19. The multilayer structure according to claim 16 wherein said tube comprises, in the following order from the inside outwards, placed against one another, optionally a fluoropolymer layer, a radiation-grafted fluoropolymer layer, a PVC layer, a radiation-grafted fluoropolymer layer and, optionally, a fluoropolymer layer.

20. The multilayer structure according to claim 16 wherein said tube comprises, in the following order from the inside outwards, placed against one another, a PVC layer, a radiation-grafted fluoropolymer layer and a PVC layer.
